(19) United States
(12) Patent Application Publication
(10) Pub. No.: US 2004/0086356 A1
(43) Pub. Date: May 6, 2004

(54) Rivet structure

(76) Inventor: Jinn-Shing Chen, Fongyuan City (TW)

Correspondence Address: Alan D. Kamrath, Rider Bennett, LLP, Suite 2000, 333 South Seventh Street, Minneapolis, MN, 55402, US

(21) Appl. No.: 10/696,868

(22) Filed: Oct. 30, 2003

Related U.S. Application Data
(63) Continuation-in-part of application No. 10/184,951, filed on Jul. 1, 2002, now abandoned.

(51) Int. Cl. F16B 37/04

(52) U.S. Cl. 411/182

(57) ABSTRACT

A rivet structure includes a main body having a first end formed with an enlarged head and a second end formed with an extended column. The main body is provided with four opposite fixing plates each having a tapered face and each having a bottom face. The bottom faces of the four fixing plates form a square shaped configuration. Thus, the rivet structure can be combined with an article rigidly and stably, thereby preventing the rivet structure from being rotated relative to the article.

### CROSS-REFERENCES TO RELATED APPLICATIONS

The present invention is a continuation-in-part application of the co-pending U.S. Ser. No. 10/184,951, filed on Jul. 1, 2002.

### BACKGROUND OF THE INVENTION

1. Field of the Invention

The present invention relates to a rivet structure, and more particularly to a rivet structure that can be combined with an article rigidly and stably, thereby preventing the rivet structure from being rotated relative to the article.

2. Description of the Related Art

A conventional rivet structure in accordance with the prior art shown in FIGS. 5 and 6 comprises a main body 3 having a first end formed with an enlarged head 5, a mediate portion formed with a neck 7 and a second end formed with an extended column 8. The extended column 8 has an inner wall formed with an inner thread 6.

In assembly, the main body 3 is riveted into a rivet hole 2 of a first article 1 and is punched on the first article 1, so that the enlarged head 5 of the main body 3 is pressed on a first side of the rivet hole 2 of the first article 1 and the extended column 8 of the main body 3 is expanded and pressed on a second side of the rivet hole 2 of the first article 1 as shown in FIG. 6. Then, a locking screw 4 is extended through a second article 9 and is screwed into the inner thread 6 of the extended column 8, so that the locking screw 4 is fixed on the main body 3, and the first article 1 is combined with the second article 9. However, the rivet hole 2 of the first article 1 is easily deformed during the riveting process.

Another conventional rivet structure is disclosed in U.S. Pat. No. 5,564,873 entitled by “SELF-ATTACHING FASTENING ELEMENT AND METHOD OF ATTACHMENT”. In the U.S. Pat. No. 5,564,873, the fastener 20 comprises a body portion 22 having a plurality of flat surfaces 40, so that the fastener 20 cannot be inserted into the workpiece easily and conveniently.

Another conventional rivet structure is disclosed in U.S. Pat. No. 5,493,883 entitled by “AXIAL PIN TUMBLER LOCK”. In the U.S. Pat. No. 5,493,883, the lock shell 10 comprises a plurality lugs 60 each having a flat surface, so that lock shell 10 cannot be inserted into the workpiece easily and conveniently.

### SUMMARY OF THE INVENTION

The present invention is to mitigate and/or obviate the disadvantage of the conventional rivet structure.

The primary objective of the present invention is to provide a rivet structure that can be combined with an article rigidly and stably, thereby preventing the rivet structure from being rotated relative to the article.

Another objective of the present invention is to provide a rivet structure, wherein each of the four fixing plates has a tapered face, so that the four fixing plates can be inserted into the respective rivet hole of the article easily and conveniently.

A further objective of the present invention is to provide a rivet structure, wherein the tapered face of each of the fixing plates is penetrated into a periphery of the respective rivet hole of the article, thereby forming a tapered locking groove in the periphery of the respective rivet hole, so that the main body is locked in the respective rivet hole of the article rigidly and stably, thereby preventing the main body from being rotated relative to the article during rotation of the locking screw.

A further objective of the present invention is to provide a rivet structure, wherein the bottom faces of the four fixing plates form a square shaped configuration, thereby increasing the contact area between the main body and the respective rivet hole of the article, so that the main body cannot be rotated relative to the article during rotation of the locking screw.

In accordance with the present invention, there is provided a rivet structure comprising a main body having a first end formed with an enlarged head and a second end formed with an extended column, wherein:

the main body is provided with four opposite fixing plates;

each of the four fixing plates has a tapered face; and

each of the four fixing plates has a bottom face, and the bottom faces of the four fixing plates form a square shaped configuration.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away cross-sectional perspective view of a rivet structure in accordance with the preferred embodiment of the present invention;

FIG. 2 is a plan cross-sectional view of the rivet structure as shown in FIG. 1;

FIG. 3 is an exploded perspective view showing the rivet structure being combined with two articles and a locking screw;

FIG. 4 is a partially cut-away plan cross-sectional assembly view of the rivet structure as shown in FIG. 3;

FIG. 5 is an exploded perspective view of a conventional rivet structure and a locking screw in accordance with the prior art; and

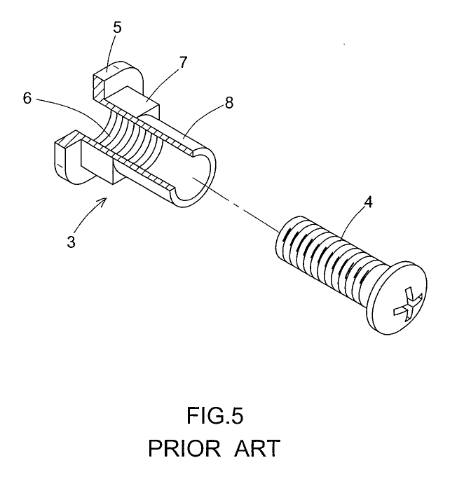

FIG. 6 is a partially cut-away plan cross-sectional assembly view of the conventional rivet structure and the locking screw as shown in FIG. 5.

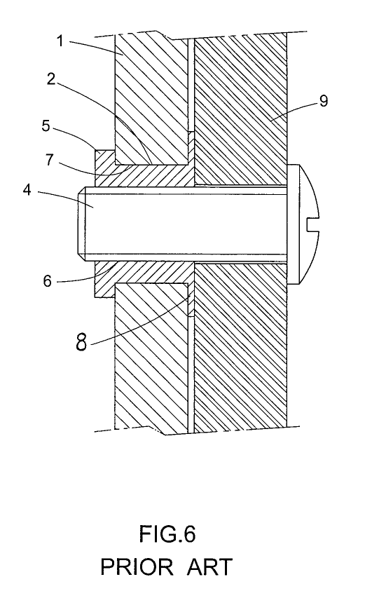

### DETAILED DESCRIPTION OF THE INVENTION

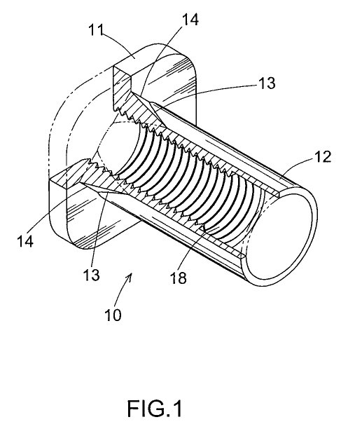

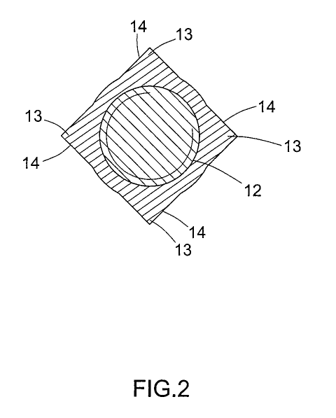

Referring to the drawings and initially to FIGS. 1 and 2, a rivet structure in accordance with the preferred embodiment of the present invention comprises a main body 10 having a first end formed with an enlarged head 11 and a second end formed with an extended column 12. The extended column 12 has an inner wall formed with an inner thread 18.

The main body 10 is provided with four opposite fixing plates 13 each having a pyramid shape. Preferably, the four fixing plates 13 are arranged in a symmetrical manner. Preferably, each of the four fixing plates 13 is formed on a connection between the enlarged head 11 and the extended column 12. Preferably, each of the four fixing plates 13 is formed on a side of the enlarged head 11 and is extended to a periphery of the extended column 12.

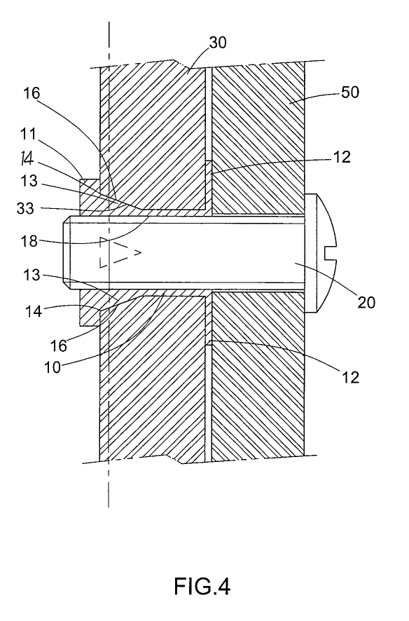

As shown in FIG. 4, each of the four fixing plates 13 has a tapered face 16 having a thickness gradually reduced from the enlarged head 11 to the periphery of the extended column 12.

As shown in FIGS. 1 and 2, each of the four fixing plates 13 has a bottom face 14, and the bottom faces 14 of the four fixing plates 13 form a square shaped configuration.

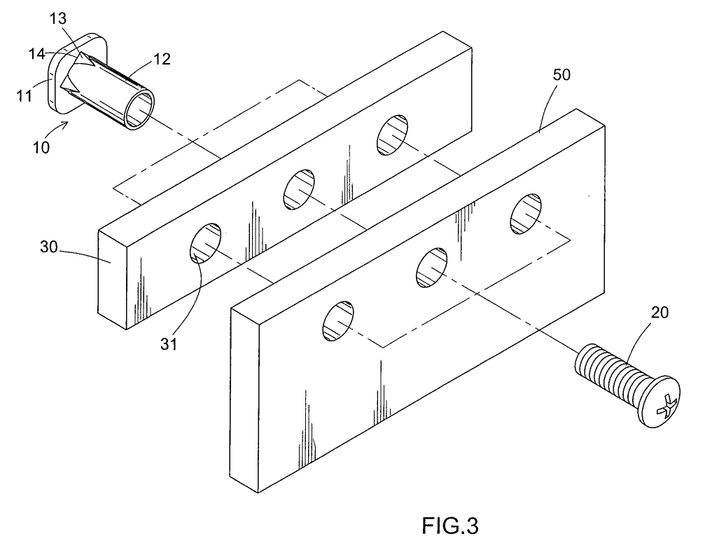

In assembly, referring to FIGS. 3 and 4 with reference to FIGS. 1 and 2, the main body 10 is riveted on a first article 30 which is formed with a plurality of rivet holes 31. Each of the rivet holes 31 of the first article 30 has a diameter equal to an outer diameter of the extended column 12 of the main body 10. Thus, the main body 10 is riveted into one of the rivet holes 31 of the first article 30 and is punched on the first article 30, so that the enlarged head 11 of the main body 10 is pressed on a first side of the rivet hole 31 of the first article 30 and the extended column 12 of the main body 10 is expanded and pressed on a second side of the rivet hole 31 of the first article 30 as shown in FIG. 4. Then, a locking screw 20 is extended through a second article 50, and is screwed into the inner thread 18 of the extended column 12 of the main body 10, so that the locking screw 20 is fixed on the main body 10, and the first article 30 is combined with the second article 50 rigidly and stably.

Accordingly, after the main body 10 is riveted into the respective rivet hole 31 of the first article 30, the tapered face 16 of each of the four fixing plates 13 of the main body 10 is penetrated into a periphery of the respective rivet hole 31 of the first article 30, thereby forming a tapered locking groove 33 in the periphery of the respective rivet hole 31 of the first article 30, so that the main body 10 is locked in the respective rivet hole 31 of the first article 30 rigidly and stably, thereby preventing the main body 10 from being rotated relative to the first article 30 during rotation of the locking screw 20.

In addition, each of the four fixing plates 13 of the main body 10 has a tapered face 16, so that the four fixing plates 13 of the main body 10 can be inserted into the respective rivet hole 31 of the first article 30 easily and conveniently.

Further, the bottom faces 14 of the four fixing plates 13 of the main body 10 form a square shaped configuration, thereby increasing the contact area between the main body 10 and the respective rivet hole 31 of the first article 30, so that the main body 10 cannot be rotated relative to the first article 30 during rotation of the locking screw 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A rivet structure comprising a main body having a first end formed with an enlarged head and a second end formed with an extended column, wherein:
the main body is provided with four opposite fixing plates;
each of the four fixing plates has a tapered face; and
each of the four fixing plates has a bottom face, and the bottom faces of the four fixing plates form a square shaped configuration.

2. The rivet structure in accordance with claim 1, wherein the extended column has an inner wall formed with an inner thread.

3. The rivet structure in accordance with claim 1, wherein each of the four fixing plates has a pyramid shape.

4. The rivet structure in accordance with claim 1, wherein the four fixing plates are arranged in a symmetrical manner.

5. The rivet structure in accordance with claim 1, wherein each of the four fixing plates is formed on a connection between the enlarged head and the extended column.

6. The rivet structure in accordance with claim 1, wherein each of the four fixing plates is formed on a side of the enlarged head and is extended to a periphery of the extended column.

7. The rivet structure in accordance with claim 1, wherein the tapered face of each of the four fixing plates has a thickness gradually reduced from the enlarged head to the periphery of the extended column.

8. The rivet structure in accordance with claim 1, wherein the main body is riveted on an article which is formed with a rivet hole, and the tapered face of each of the four fixing plates of the main body is penetrated into a periphery of the rivet hole of the article, thereby forming a tapered locking groove in the periphery of the rivet hole of the article, so that the main body is locked in the rivet hole of the article rigidly and stably, thereby preventing the main body from being rotated relative to the article.

9. The rivet structure in accordance with claim 8, wherein the rivet hole of the article has a diameter equal to an outer diameter of the extended column of the main body.
